(19) United States
(12) Patent Application Publication
(10) Pub. No.: US 2026/0143216 A1
(43) Pub. Date: May 21, 2026

(54) OPTICAL APPARATUS, SYSTEM, MOVABLE APPARATUS, AND METHOD OF MANUFACTURING OPTICAL APPARATUS

(71) Applicant: CANON KABUSHIKI KAISHA, Tokyo (JP)

(72) Inventors: KENTO SAITO, Saitama (JP); TATSUYA TANAKA, Tokyo (JP)

(21) Appl. No.: 19/357,475

(22) Filed: Oct. 14, 2025

(30) Foreign Application Priority Data
Nov. 18, 2024 (JP) 2024-201030

(51) Int. Cl. H04N 23/54; G02B 7/02; G03B 17/12; G03B 30/00; H04N 23/51; H04N 23/52; H04N 23/55; H04N 23/57

(52) U.S. Cl. CPC H04N 23/54; G02B 7/021; G03B 17/12; G03B 30/00; H04N 23/51; H04N 23/52; H04N 23/55; H04N 23/57

(57) ABSTRACT

An optical apparatus includes a lens barrel that houses an optical element, and a holder that holds an image sensor, and has an opening through which an adhesive is to be applied to an outer surface of the lens barrel. The adhesive adheres the outer surface of the lens barrel and an area of an inner surface of the holder other than the opening to each other.

### BACKGROUND

### Field of the Technology

The aspect of the disclosure relates to one or more embodiments of an optical apparatus, a system, a movable apparatus, and a method of manufacturing an optical apparatus.

### Description of the Related Art

Some of the known optical apparatuses installed in automobiles are sensing cameras for performing a driving assistance function or an autonomous driving function, and an on-board camera (in-vehicle cameras) that images the vehicle's surroundings. Light Detection and Ranging (LiDAR) is another known optical apparatus with a sensing function.

Japanese Patent Application Laid-Open No. 2016-031530 discloses a configuration for applying an adhesive to the space between the outer surface of a lens barrel that holds lenses and the inner surface of a second lens barrel that holds an image sensor to fix them together.

### SUMMARY

One or more embodiments of an optical apparatus according to one or more aspects of the disclosure may include a lens barrel that houses an optical element, and a holder that holds an image sensor, and has an opening through which an adhesive is to be applied to an outer surface of the lens barrel. The adhesive adheres the outer surface of the lens barrel and an area of an inner surface of the holder other than the opening to each other. One or more embodiments of a system or a movable apparatus may include one or more optical apparatuses in accordance with one or more other aspects of the disclosure. One or more methods of the above one or more optical apparatuses also constitutes another aspect of the disclosure.

Features of the disclosure will become apparent from the following description of embodiments with reference to the attached drawings. The following description of embodiments will be provided by way of example.

### BRIEF DESCRIPTION OF THE DRAWINGS

FIG. 1 is a schematic diagram of an optical apparatus according to each embodiment.

FIG. 2 is a sectional view of a barrel unit according to a first embodiment.

FIGS. 3A and 3B explain a holder according to the first embodiment.

FIG. 4 is an exploded perspective view of the barrel unit according to the first embodiment.

FIG. 5 is a sectional view of a barrel unit according to a second embodiment.

FIG. 6 is an exploded perspective view of the barrel unit according to the second embodiment.

FIG. 7 is an exploded perspective view of a barrel unit according to a variation of the second embodiment.

FIG. 8 is a flowchart illustrating a manufacturing method of an optical apparatus according to each embodiment.

FIG. 9 is a functional block diagram of a system including an optical apparatus according to any one of the embodiments.

FIG. 10 is a schematic diagram of main parts in a movable apparatus including the optical apparatus according to any one of the embodiments.

FIG. 11 is a flowchart illustrating an example of the operation of the system including the optical apparatus according to any one of the embodiments.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure.

### First Embodiment

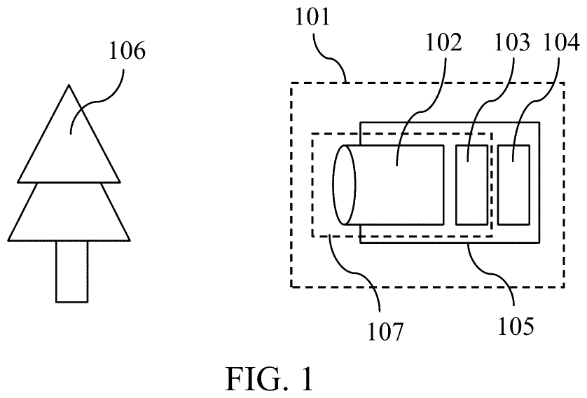

Referring now to FIG. 1, a description will be given of an optical apparatus (image pickup apparatus) 101 according to a first embodiment of the disclosure. FIG. 1 is a schematic diagram of the optical apparatus 101. The optical apparatus 101 includes a lens barrel 102, a sensor unit 103, an electrical device 104, and a housing 105. For example, in a case where the optical apparatus 101 is an on-board camera (in-vehicle camera), the lens barrel 102 functions as an imaging optical system. In a case where the optical apparatus 101 captures an image of an object 106, a signal (image capture signal) is input to a sensor unit 103 including an image sensor 19. The input signal is processed by the electrical device 104, and environmental information about the surroundings of the vehicle is acquired. The lens barrel 102, the sensor unit 103, and the electrical device 104 are held in the housing 105.

The image sensor 19 is an imaging sensor such as a CCD sensor or a CMOS sensor, and converts light condensed through the lens barrel 102 into an electrical signal. The converted electrical signal is then converted into analog or digital data, which is a component of captured image data. The obtained data is used for a driving assistance or autonomous driving system. The lens barrel unit 107 includes the lens barrel 102 and the sensor unit 103.

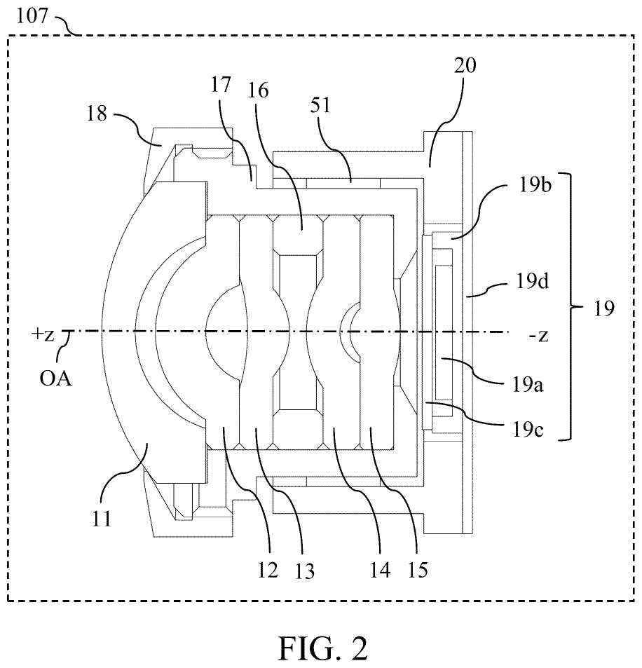

Referring now to FIG. 2, a description will be given of the structure of the lens barrel unit 107 according to this embodiment. FIG. 2 is a sectional view of the lens barrel unit 107. The lens barrel 102 includes the lens barrel 17 that houses, for example, a plurality of lenses (optical elements). The plurality of lenses include a first lens 11, a second lens 12, a third lens 13, a fourth lens 14, and a fifth lens 15, arranged in this order from the object side (+z direction) to the image side (−z direction) in a direction along the optical axis OA (optical axis direction). The lens barrel 17 also houses a spacer 16 disposed between the third lens 13 and the fourth lens 14. The plurality of lenses are held, for example, by a press ring 18 screwed with the lens barrel 17. The lens barrel 17 may include an aperture stop that limits an amount of transmitting light and determines an F-number (aperture value), which is an indicator of luminance, or a light shielding diaphragm that shields a light ray that causes ghost or aberrations.

The surface of each lens may be provided with an antireflection film, a hydrophilic film, or a water-repellent film, as necessary. The lens is made of glass, but is not limited to this example; for example, plastic molded lenses may also be used.

The spacer 16, lens barrel 17, and press ring 18 are made of metal such as aluminum alloy, or a resin material such as polyamide (PA) or polyphenylene sulfide (PPS).

The sensor unit 103 includes the image sensor 19 and the holder 20 that holds the image sensor 19. The image sensor 19 includes an image sensor (body) 19a, a package 19b, a protective glass 19c, and a printed circuit board 19d. The image sensor 19a is hermetically sealed by the package 19b and the protective glass 19c. The printed circuit board 19d is electrically connected to the image sensor 19a and soldered to the package 19b. The image sensor 19a is fixed by fastening the printed circuit board 19d to the holder 20 with screws (not illustrated). An optical filter such as a low-pass filter or an infrared cut filter may be provided between the fifth lens 15, which is located closest to the image (in the-z direction), and the protective glass 19c.

The lens barrel 102 and sensor unit 103 are fixed by adhering the lens barrel 17 to the holder 20 with an adhesive (agent) 51. The adhesive 51 is disposed in an area (space) between the outer diameter (outer surface, outer circumferential surface) of the lens barrel 17 and the inner diameter (inner surface, inner circumferential surface) of the holder 20. The adhesive 51 is, for example, an ultraviolet (UV)-curing adhesive that is curable by UV light, or a UV/thermosetting adhesive that is curable by UV light and heat.

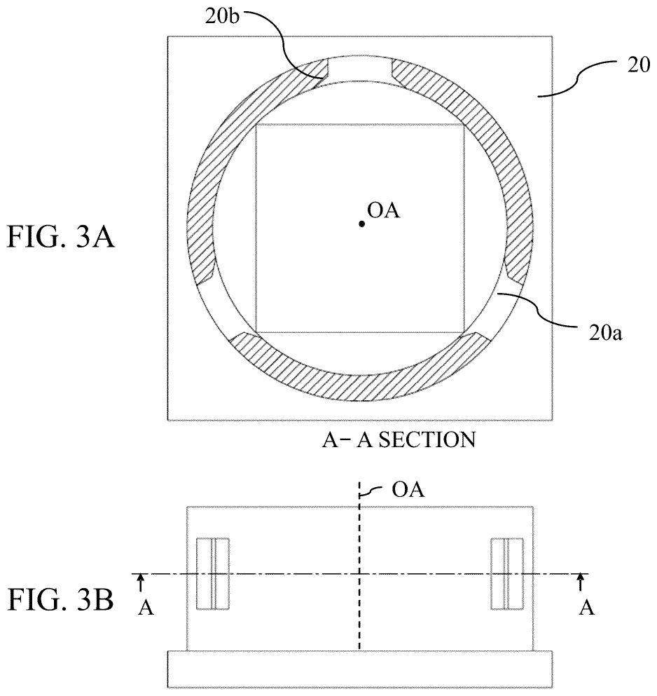

Referring now to FIGS. 3A and 3B, a description will be given of the shape of the holder 20 according to this embodiment. FIGS. 3A and 3B explain the holder 20. FIG. 3A is a sectional view of the holder 20, illustrating the cross section A-A in FIG. 3B, which is a side view of the holder 20. As illustrated in FIG. 3A, the holder 20 has three openings 20a formed at regular intervals (at an angle of 120 degrees) around the optical axis OA. The openings 20a are formed to apply the adhesive 51 to at least a part of the area (first area) between the outer diameter of the lens barrel 17 and the inner diameter of the holder 20. The openings 20a are also used to irradiate UV light to partially cure the adhesive 51. In this embodiment, one or more openings 20a may be formed, and the number of openings 20a is not limited to three.

As illustrated in FIG. 3A, the corner of the opening 20a on the inner diameter of the holder 20 has a tapered shape 20b. The tapered shape 20b has a diameter that increases toward the opening 20a along the inner diameter of the holder 20.

In this embodiment, each of the outer surface of the lens barrel 17 and the inner surface of the holder 20 has a surface whose normal direction is a radial direction perpendicular to the optical axis direction. The outer surface of the lens barrel 17 and the inner surface of the holder 20 have surfaces that face each other in the radial direction. The maximum length of the opening 20a in the optical axis direction may be longer than the maximum length in the circumferential direction around the optical axis. Thereby, the length of the adhesive surface adhered by the adhesive 51 in the optical axis direction and thereby the adhesive strength can be increased. When viewed in the radial direction perpendicular to the optical axis direction, the opening 20a is not limited to a square or rectangle, and may be, for example, an ellipse whose length in the optical axis direction is at its maximum.

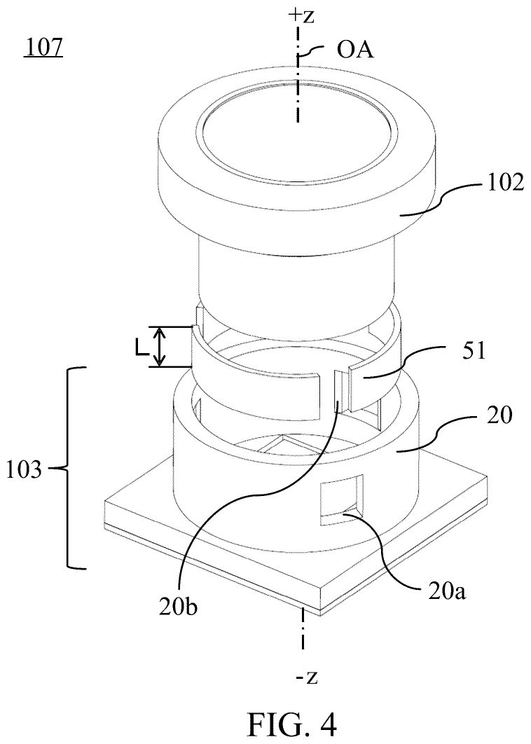

Referring now to FIG. 4, a description will be given of a method of assembling (manufacturing) the lens barrel unit 107. FIG. 4 is an exploded oblique view of the lens barrel unit 107. First, the lens barrel 102 is assembled by inserting the plurality of lenses and spacer 16 into the lens barrel 17 in the following order: fifth lens 15, fourth lens 14, spacer 16, third lens 13, second lens 12, and first lens 11. The press ring 18 is then screwed with the lens barrel 17.

Next, the sensor unit 103 is assembled by screwing the image sensor 19 into the holder 20. The assembled sensor unit 103 is held in mid-air and position-adjusted by an adjustment apparatus (not illustrated) to adjust the image sensor 19 to a position that optimizes the optical performance of the lens barrel 102. The position in the optical axis direction (z direction) and the eccentricity and tilt in the direction perpendicular to the optical axis OA of the sensor unit 103 are adjusted.

After the position of the sensor unit 103 is adjusted, the adhesive 51 is applied to the outer diameter of the lens barrel 17 through the openings 20a of the holder 20. At this time, the lens barrel 102 is rotated around the optical axis OA (z-axis) to fill at least a part of an area (space or gap) between the outer diameter of the lens barrel 17 and the inner diameter of the holder 20 with the adhesive 51. The adhesive 51 may be applied simultaneously through the plurality of openings 20a. In a case where the inner corner of each opening 20a may have a tapered shape 20b, the rotated adhesive 51 can be easily penetrated into the space between the outer diameter of the lens barrel 17 and the inner diameter of the holder 20.

After the space between the outer diameter of the lens barrel 17 and the inner diameter of the holder 20 is filled with the adhesive 51, UV light is irradiated onto a part of the adhesive 51 through the openings 20a to cure the part of the adhesive 51. Thereby, the sensor unit 103 can be fixed at a proper position relative to the lens barrel 102. After the adhesive 51 is cured, the lens barrel unit 107, in which the position of the sensor unit 103 has been fixed, is moved to a heating furnace or the like, where the adhesive 51 is cured (fully hardened) by heating it, for example, to 80° C. or higher. A sealant (not illustrated) may be provided in the space in the opening 20a that is not filled with the adhesive 51. Thereby, dust, water droplets, and the like can be prevented from entering through the opening 20a.

The lens barrel unit 107 assembled as described above can ensure a sufficient adhesive area by increasing the length L of the adhesive 51 in the optical axis direction according to the size of the opening 20a of the holder 20 and rotating the lens barrel 102. Thereby, the adhesive strength can be increased.

By applying the adhesive 51 through the openings 20a, sufficient work space can be provided for the diameter of the needle to apply the adhesive 51, and a decrease in workability and therefore a decrease in assembly efficiency can be suppressed.

In this embodiment, the lens barrel 102 includes five lenses, but this embodiment is not limited to this example and the number of lenses may be two or more. The lens barrel 102 may also have only one lens. The optical apparatus 101 according to this embodiment is applied to an on-board camera for driving assistance or autonomous driving, but is not limited to this example. This embodiment can also be applied to an optical apparatus other than the on-board camera.

### Second Embodiment

Next, a second embodiment according to the disclosure will be described. In the first embodiment, the outer diameter of the lens barrel 17 is the same on the outer circumferential surface. On the other hand, this embodiment will discuss a lens barrel unit 207 in which a groove portion is provided on the outer diameter of the lens barrel 27. This embodiment will omit a description of components similar to those in the first embodiment.

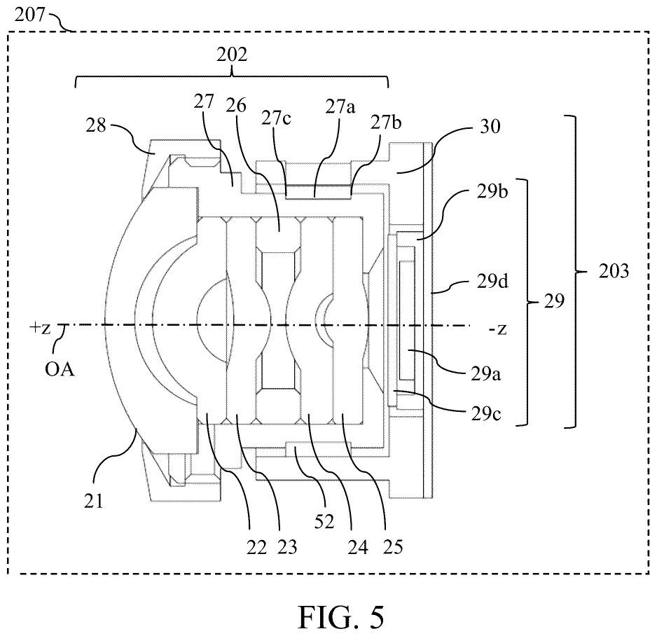

The structure of the lens barrel unit 207 according to this embodiment will be described with reference to FIG. 5. FIG. 5 is a sectional view of the lens barrel unit 207. The lens barrel unit 207 includes a lens barrel 202 and a sensor unit 203. The lens barrel 202 includes a lens barrel 27 that houses, for example, multiple lenses (optical elements). The multiple lenses include a first lens 21, a second lens 22, a third lens 23, a fourth lens 24, and a fifth lens 25, arranged in this order from the object side (+z direction) to the image side (−z direction). The lens barrel 27 also houses a spacer 26, which is disposed between the third lens 23 and the fourth lens 24. The multiple lenses are held, for example, by a press ring 28 screwed to the lens barrel 27.

The spacer 26, lens barrel 27, and press ring 28 are made of metal such as aluminum alloy, or a resin material such as polyamide (PA) or polyphenylene sulfide (PPS).

The sensor unit 203 includes an image sensor 29 and a holder 30 that holds the image sensor 29. The image sensor 29 includes an image sensor (body) 29a, a package 29b, a protective glass 29c, and a printed circuit board 29d. The image sensor 29a is sealed by the package 29b and the protective glass 29c. The printed circuit board 29d is soldered to the package 29b. The image sensor 29 is fixed to the holder 30 by fastening the printed circuit board 29d to it with screws (not illustrated). An optical filter such as a low-pass filter or an infrared cut filter may be provided between the fifth lens 25, which is disposed closest to the image pane (in the-z direction), and the protective glass 29c.

The lens barrel 202 and sensor unit 203 are fixed to the holder 30 by adhering the barrel 27 to the holder 30 with an adhesive 52. The adhesive 52 is disposed in the area (space or gap) between the outer surface (outer circumference) of the barrel 27 and the inner surface (inner circumference) of the holder 30. The adhesive 52 is, for example, a UV-curing adhesive that is curable by UV light, or a UV/thermosetting adhesive that is curable by UV light and heat.

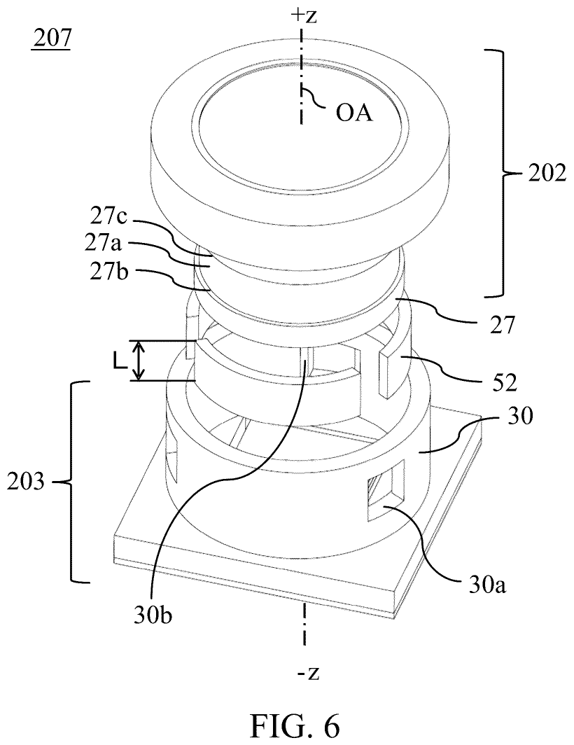

Next, with reference to FIG. 6, an assembly method (manufacturing method) for the lens barrel unit 207 will be described. FIG. 6 is an exploded perspective view of the lens barrel unit 207. A groove portion 27a is provided on the outer diameter of the lens barrel 27. A first wall surface 27b is provided on the image side (−z direction) of the groove portion 27a, and a second wall surface 27c is provided on the object side (+z direction) of the groove portion 27a. That is, the outer diameter of the lens barrel 27 is provided with the groove portion 27a having the first wall surface 27b and the second wall surface 27c on both sides (the image plane side and the object side) in the optical axis direction, and the adhesive 52 is applied to the groove portion 27a. A plurality of openings 30a are formed in the holder 30 at regular intervals around the optical axis. The corner of the opening 30a on the inner diameter of the holder 30 has a tapered shape 30b.

First, the lens barrel 202 is assembled by inserting the multiple lenses and spacer 26 into the lens barrel 27 in the following order: the fifth lens 25, fourth lens 24, spacer 26, third lens 23, second lens 22, and first lens 21. The press ring 28 is then screwed with the lens barrel 27.

Next, the sensor unit 203 is assembled by fastening the image sensor 29 to the holder 30 with screws (not illustrated). The assembled sensor unit 203 is held in midair and its position adjusted by an adjustment apparatus (not illustrated) to adjust the image sensor 29 to a position that optimizes the optical performance of the lens barrel 202. The position in the optical axis direction (z direction) and the eccentricity and tilt in the direction perpendicular to the optical axis OA of the sensor unit 203 are adjusted.

After the position of the sensor unit 203 is adjusted, the adhesive 52 is applied to the outer diameter of the lens barrel 27 through the openings 30a in the holder 30. At this time, the adhesive 52 is filled by using the groove portion 27a, first wall surface 27b, and second wall surface 27c of the lens barrel 27 as adhesive surfaces. That is, by rotating the lens barrel 202 around the optical axis OA (z-axis), the adhesive 52 is filled in at least a part of the area between the outer diameter of lens barrel 27 and the inner diameter of holder 30 (the area formed by the groove portion 27a, first wall surface 27b, and second wall surface 27c). The adhesive 52 may be applied simultaneously through the plurality of openings 30a. In a case where the inner corner of the openings 30a may have the tapered shape 30b, the rotated adhesive 52 can be easily penetrated into the space between the outer diameter of the lens barrel 27 and the inner diameter of the holder 30.

After the adhesive 52 is filled in the space between the outer diameter of lens barrel 27 and the inner diameter of holder 30, UV light is irradiated onto a part of the adhesive 52 through the openings 30a to cure the part of the adhesive 52. Thereby, the sensor unit 203 can be fixed at a proper position relative to the lens barrel 202. After the adhesive 52 is cured, the lens barrel unit 207 in which the position of the sensor unit 203 has been fixed is moved to a heating furnace or the like, where the adhesive 52 is cured (fully hardened) by heating it, for example, to 80° C. or higher. A sealant (not illustrated) may be provided in the space in the opening 30a that is not filled with the adhesive 52. Thereby, dust, water droplets, and the like can be prevented from entering through the opening 30a.

The lens barrel unit 207 assembled as described above can ensure a sufficient bonding area by increasing the length L of the adhesive 52 in the optical axis direction according to the size of the opening 30a of the holder 30 and rotating the lens barrel 202. Thereby, the adhesive strength can be increased.

By applying the adhesive 52 through the opening 30a, sufficient work space can be provided for the diameter of the needle to apply the adhesive 52, and a decrease in workability and therefore a decrease in assembly efficiency can be suppressed.

When the ambient temperature changes, the adhesive 52 contracts due to linear expansion. The amount of expansion and contraction of a material due to temperature changes can be calculated using the linear expansion coefficient, representative length, and temperature change amount. However, in the case of adhesives, because the adhesion surface is fixed to the adherend object, the adhesive shape may not expand and contract uniformly when the temperature changes. More specifically, when the adhesive expands or contracts due to temperature changes, the stress is generated within the adhesive, and deformation may occur in a direction that avoids the adhesion surface.

In this embodiment, by using the first wall surface 27b and the second wall surface 27c of the lens barrel 27 as the adhesion surfaces, deformation of the adhesive 52 in the optical axis direction (z direction) due to stress caused by ambient temperature changes can be suppressed. Thereby, the sensor unit 203 can follow the position that optimizes the optical performance of the lens barrel 202, even in a case where the ambient temperature changes.

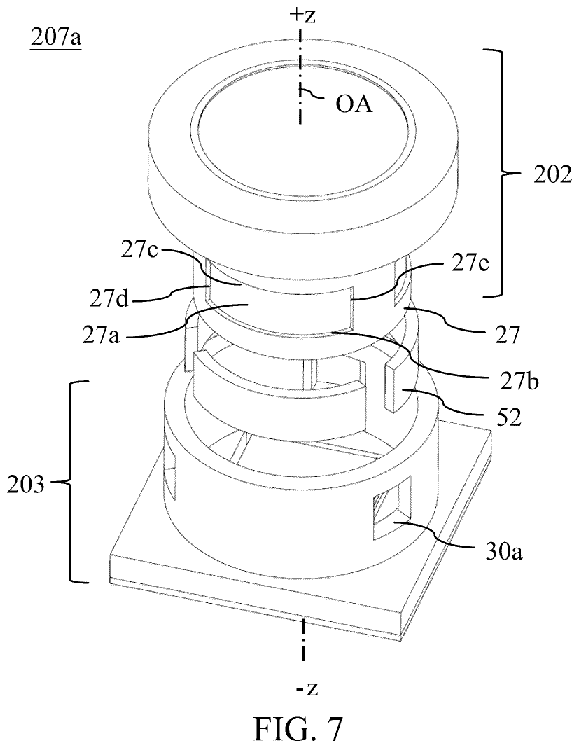

Referring now to FIG. 7, a lens barrel unit 207a according to a variation of this embodiment will be described. FIG. 7 is an exploded perspective view of the lens barrel unit 207a. In the lens barrel unit 207a, the outer diameter of the lens barrel 27 is provided with a third wall surface 27d and a fourth wall surface 27e extending parallel to the optical axis direction, in addition to the groove portion 27a, first wall surface 27b, and second wall surface 27c. That is, in this variation, the groove portion 27a has the first wall surface 27b and the second wall surface 27c on both sides in the optical axis direction, as well as the third wall surface 27d and the fourth wall surface 27e on both sides in the circumferential direction around the optical axis. Multiple groove portions 27a are arranged at regular intervals around the optical axis OA (z-direction).

In this variation, the number of groove portions 27a is three (the number of adhesive surfaces adhered by the adhesive 52 is three), but this variation is not limited to this example. In this variation, for example, the number of openings 30a in the holder 30 is equal to the number of groove portions 27a. The position (phase) of opening 30a and the position (phase) of groove portion 27a may be arranged so as to be different from each other.

By using the first wall surface 27b, second wall surface 27c, third wall surface 27d, and fourth wall surface 27e as the adhesion surfaces, this variation suppresses deformation of the adhesive 52 due to stress caused by ambient temperature changes, even in a direction perpendicular to the optical axis direction (z direction). Therefore, even if the ambient temperature changes, the sensor unit 203 can follow the position that optimizes the optical performance of the lens barrel 202.

In this embodiment, the lens barrel 202 includes five lenses, but this embodiment is not limited to this example and the number of lenses may be two or more. The lens barrel 202 may also have only one lens. The optical apparatus 101 according to this embodiment is applied to an on-board camera for driving assistance or autonomous driving, but is not limited to this example. This embodiment can also be applied to an optical apparatus other than the on-board camera.

### Method of Manufacturing Optical Apparatus

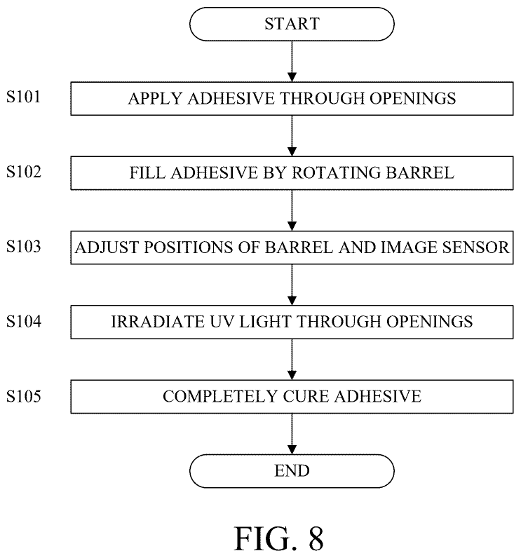

Referring now to FIG. 8, a method of manufacturing the optical apparatus 101 according to each embodiment will be described. FIG. 8 is a flowchart illustrating the method of manufacturing the optical apparatus 101.

First, in step S101, the adhesive 51 (52) is applied to the space between the outer surface of the lens barrel 17 (27) and the holder 20 (30) through the openings 20a (30a) of the holder 20 (30) that holds the image sensor 19 (29).

Next, in step S102, the lens barrel 17 (27) is rotated around the optical axis relative to the holder 20 (30), and the adhesive 51 (52) is filled in at least a part of the area between the outer surface of the lens barrel 17 (27) and the inner surface of the holder 20 (30). Step S102 is not limited to rotating the lens barrel 17 (27); the holder 20 (30) may also be rotated. That is, in step S102, at least one of the holder 20 (30) and the lens barrel 17 (27) is rotated around the optical axis (the relative position in the circumferential direction between the holder 20 (30) and the lens barrel 17 (27) may be changed). Step S102 can be performed after the processing of step S101 is completed (after the adhesive has been applied) or during the processing of step S101 (while the adhesive is being applied).

Next, in step S103, the positions of the lens barrel 17 (27) and the image sensor 19 (29) are adjusted. Next, in step S104, UV light is irradiated through the openings 20a (30a) of the holder 20 (30) to partially cure the adhesive 51 (52). Next, in step S105, the adhesive 51 (52) is cured (fully cured). For example, the adhesive 51 (52) is thermally cured, but this embodiment is not limited to this example. In a case where the adhesive is a naturally curable adhesive, the adhesive can be cured over a predetermined period of time.

### System

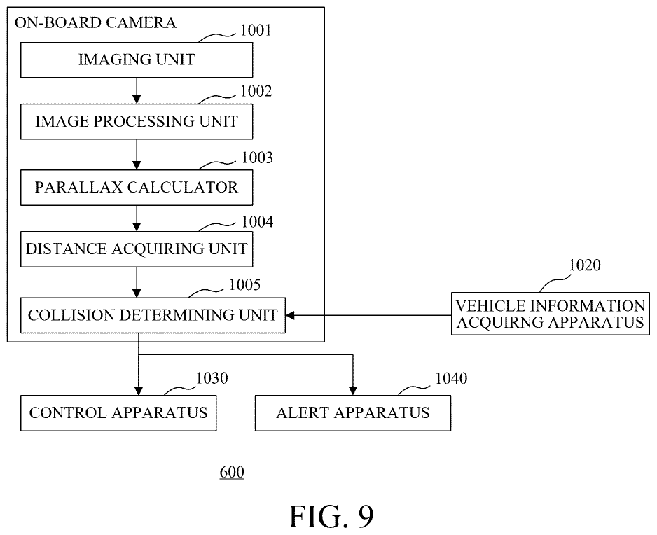

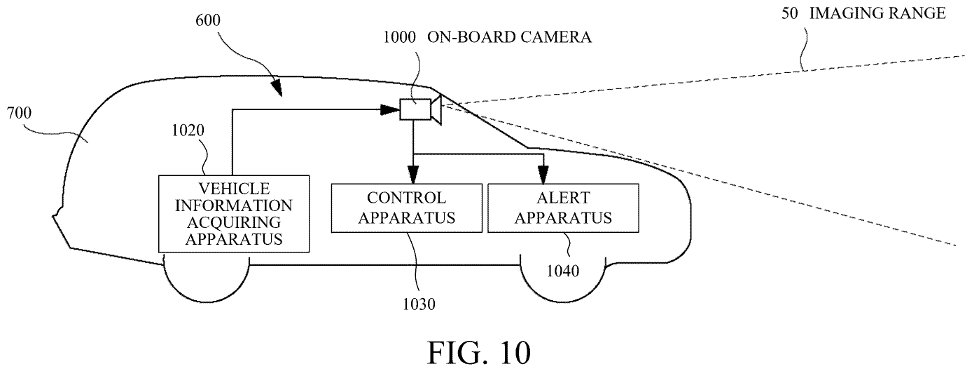

FIG. 9 is a configuration diagram of an on-board camera (optical apparatus) 1000 and a system (on-board system, control system, driving assistance apparatus) 600 having the same according to this embodiment. The on-board camera 1000 corresponds to the optical apparatus (image pickup apparatus) 101 according to any one of the above embodiments. The system 600 is a system held by a movable unit (movable apparatus) such as an automobile (vehicle) and configured to assist in the driving (maneuvering) of the vehicle based on image information on the vehicle's surroundings acquired by the on-board camera 1000. FIG. 10 is a schematic diagram of a vehicle 700 as a movable apparatus having the system 600. While FIG. 10 illustrates that the imaging range 50 of the on-board camera 1000 is set in front of the vehicle 700, the imaging range 50 may also be set behind or to the side of the vehicle 700.

As illustrated in FIG. 9, the system 600 includes the on-board camera 1000, a vehicle information acquiring apparatus 1020, a control apparatus (control unit, ECU: Electronic Control Unit) 1030, and an alert apparatus (alert unit) 1040. The on-board camera 1000 includes an imaging unit 1001, an image processing unit 1002, a parallax calculator 1003, a distance acquiring unit 1004, and a collision determining unit 1005. A processor includes the image processing unit 1002, parallax calculator 1003, distance acquiring unit 1004, and collision determining unit 1005. The imaging unit 1001 includes the optical system according to any of the above embodiments and an image sensor.

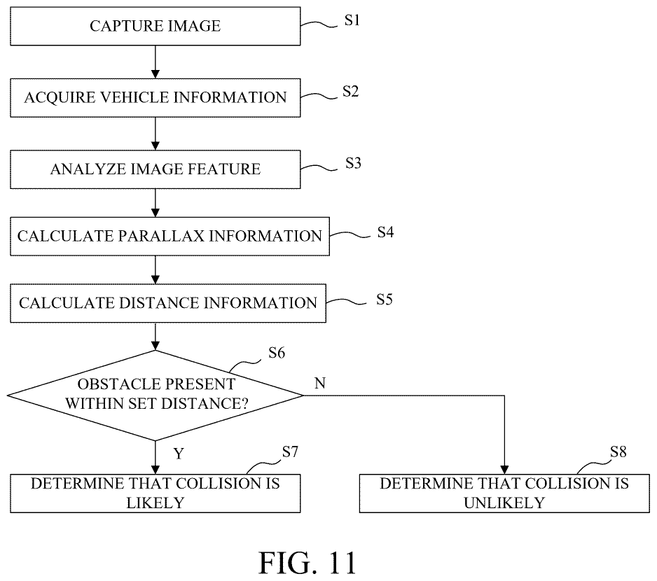

FIG. 11 is a flowchart illustrating an example of the operation of the system 600 according to this embodiment. The operation of the system 600 will be discussed below in accordance with this flowchart.

First, in step S1, the imaging unit 1001 captures images of objects such as obstacles and pedestrians around the vehicle, and acquires multiple image data (parallax image data).

In step S2, vehicle information is acquired by the vehicle information acquiring apparatus 1020. The vehicle information includes the speed, yaw rate, steering angle of the vehicle, etc.

In step S3, the image processing unit 1002 performs image processing for the multiple image data acquired by the imaging unit 1001. More specifically, image feature analysis is performed to analyze feature amounts such as the amount, direction, and density value of edges in the image data. Here, the image feature analysis may be performed for each of the multiple image data, or for only part of the multiple image data.

In step S4, the parallax calculator 1003 calculates parallax (image shift) information between the multiple image data acquired by the imaging unit 1001. Known methods such as the SSDA method and area correlation method can be used to calculate the parallax information, and thus a description of these methods will be omitted in this embodiment. Steps S2, S3, and S4 may be performed in the above order, or may be processed in parallel.

In step S5, the distance acquiring unit 1004 acquires (calculates) distance information to the object imaged by the imaging unit 1001. The distance information can be calculated based on the parallax information calculated by the parallax calculator 1003 and the internal and external parameters of the imaging unit 1001. The distance information here refers to information regarding the relative position of the object, such as the distance to the object, the defocus amount, and the image shift amount, and may directly represent a distance value of an object in an image, or may indirectly represent information corresponding to the distance value.

In step S6, the collision determining unit 1005 determines whether the distance to the object is within a predetermined distance range, using the vehicle information acquired by the vehicle information acquiring apparatus 1020 and the distance information calculated by the distance acquiring unit 1004. Thereby, it is possible to determine whether an object exists within a set distance around the vehicle and determine the likelihood of collision between the vehicle and the object. The collision determining unit 1005 determines that the “collision is likely” in a case where the object is present within the set distance (step S7), and determines that the “collision is unlikely” in a case where there is no object within the set distance (step S8).

Next, in a case where the collision determining unit 1005 determines that the “collision is likely,” it notifies (transmits) the determination result to the control apparatus 1030 and the alert apparatus 1040. At this time, the control apparatus 1030 controls the vehicle based on the determination result of the collision determining unit 1005 (step S6), and the alert apparatus 1040 issues an alert to the vehicle user (driver, passenger) based on the determination result of the collision determining unit 1005 (step S7). The notification of the determination result may be sent to at least one of the control apparatus 1030 and the alert apparatus 1040.

The control apparatus 1030 can control the movement of the vehicle by outputting a control signal to the drive unit of the vehicle (engine, motor, etc.). For example, the optical apparatus 101 controls the vehicle to brake, release the accelerator, turn the steering wheel, or generate a control signal to generate the braking force on each wheel to suppress the output of the engine or motor. The alert apparatus 1040 also alerts the user, for example, by issuing an alarm sound, displaying warning information on a screen of a car navigation system, or vibrating the seat belt or steering wheel.

Thus, the system 600 according to this embodiment can effectively detect an object through the above processing, and can avoid a collision between the vehicle and the object. In particular, applying the optical apparatus 101 according to each embodiment to the system 600 can detect an object and determine a collision over a wide angle of view while reducing the size of the on-board camera 1000 and increasing the flexibility of its placement.

A variety of embodiments are conceivable for calculating distance information. As an example, the image sensor of the imaging unit 1001 may use a pupil division type image sensor that has a plurality of pixels regularly arranged in a two-dimensional array. In the pupil division type image sensor, one pixel unit includes a microlens and a plurality of photoelectric converters, receives a pair of light beams that pass through different regions in the pupil of the optical system, and outputs a pair of image data from each photoelectric converter.

The image shift amount in each region is calculated by a correlation calculation between the pair of image data, and the distance acquiring unit 1004 calculates image shift map data that represents the distribution of the image shift amounts. Alternatively, the distance acquiring unit 1004 may further convert the image shift amount into a defocus amount and generate defocus map data that represents the distribution of the defocus amounts (distribution of captured images on a two-dimensional plane). The distance acquiring unit 1004 may also acquire distance map data of the distance to the object converted from the defocus amount.

The system 600 and vehicle (movable apparatus) 700 may include a notification apparatus (notification unit) that notifies the system manufacturer, movable apparatus dealer, etc., in a case where the vehicle 700 collides with an obstacle. For example, the notification apparatus may be one that transmits information regarding a collision between the vehicle 700 and the obstacle (collision information) to a previously set external notification destination via email or the like.

Automatically notifying collision information using the notification apparatus in this way can promptly take measures such as inspection and repair after the collision occurs. The destination of the collision information may be an insurance company, a medical institution, the police, or any other entity set by the user. The notification apparatus may also be configured to notify the destination of not only collision information but also information about malfunctions of various components and information about the consumption of consumables. The presence or absence of a collision may be detected using distance information acquired based on the output from a light receiver, or may be performed by another detector (sensor).

While this embodiment discusses application of the system 600 to driving assistance (collision damage mitigation), the system 600 may also be applied to cruise control (including adaptive cruise control) and autonomous driving. The system 600 is not limited to vehicles such as automobiles, and may be applied to a movable unit such as a ship, an aircraft, and an industrial robot. Each embodiment is applicable not only to a movable unit, but also to a variety of devices that use object recognition, such as intelligent transport systems (ITS).

Each embodiment applies the adhesive agent through the opening of the holder that holds the image sensor, rotates the lens barrel around the optical axis, and fills the adhesive in the space between the inner diameter of the holder and the outer diameter of the lens barrel. Thereby, the length of the adhesion surface in the optical axis direction and the adhesive strength can be increased. Applying the adhesive through the opening can provide sufficient work space for the diameter of the needle that applies the adhesive, and prevent a decrease in assembly efficiency that would otherwise be associated with a decrease in workability. Therefore, each embodiment can provide an optical apparatus that is easy to assemble and has high adhesive strength.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD™), a flash memory device, a memory card, and the like.

While the disclosure has described example embodiments, it is to be understood that the disclosure is not limited to the example embodiments. The scope of the following claims is to be accorded the broadest interpretation so as to encompass all such modifications and equivalent structures and functions.

This application claims the benefit of Japanese Patent Application No. 2024-201030, which was filed on Nov. 18, 2024, and which is hereby incorporated by reference herein in its entirety.

What is claimed is:

1. An optical apparatus comprising:
a lens barrel that houses an optical element; and
a holder that holds an image sensor, and has an opening through which an adhesive is to be applied to an outer surface of the lens barrel,
wherein the adhesive adheres the outer surface of the lens barrel and an area of an inner surface of the holder other than the opening to each other.

2. The optical apparatus according to claim 1, wherein each of the outer surface and the area of the inner surface other than the opening has a part whose normal direction is perpendicular to an optical axis direction.

3. The optical apparatus according to claim 2, wherein the part of the outer surface and the part of the area of the inner surface other than the opening face each other in the normal direction.

4. The optical apparatus according to claim 1, wherein a maximum length of the opening in an optical axis direction is longer than a maximum length in a circumferential direction.

5. The optical apparatus according to claim 4, wherein the opening is rectangular or elliptical when viewed in a radial direction.

6. The optical apparatus according to claim 1, wherein the area of the inner surface other than the opening has a tapered shape having a diameter that increases toward the opening.

7. The optical apparatus according to claim 1, wherein a plurality of the openings are arranged at regular intervals around an optical axis.

8. The optical apparatus according to claim 1, wherein the outer surface of the lens barrel has a groove portion that includes a first wall surface and a second wall surface on both sides of the groove portion in an optical axis direction, and
wherein the adhesive is applied to the groove portion.

9. The optical apparatus according to claim 8, wherein the groove portion has a third wall surface and a fourth wall surface on both sides of the groove portion in a circumferential direction around the optical axis, and
wherein a plurality of groove portions are arranged at regular intervals.

10. The optical apparatus according to claim 1, further comprising a sealant provided to the opening.

11. The optical apparatus according to claim 1, further comprising:
a circuit board connected to the image sensor; and
a housing that holds the circuit board.

12. A system comprising:
the optical apparatus according to claim 1;
one or more memories storing instructions; and
one or more processors that, upon execution of the instructions, operate to determine a likelihood of collision between a movable apparatus and an object based on distance information on the object obtained from an output from the optical apparatus.

13. A movable apparatus comprising:
the optical apparatus of claim 1,
wherein the movable apparatus holds the optical apparatus and is movable.

14. A method for manufacturing an optical apparatus that includes a lens barrel that houses an optical element, and a holder that holds an image sensor, the method comprising:
applying an adhesive to an outer surface of the lens barrel through an opening formed in the holder;
rotating at least one of the holder and the lens barrel around an optical axis so that the adhesive applied to the outer surface of the lens barrel is applied to an area of an inner surface of the holder other than the opening; and
adhering the outer surface of the lens barrel and the area of the inner surface other than the opening to each other with the adhesive.

15. The method according to claim 14, further comprising, after applying:
irradiating the adhesive in the opening with ultraviolet light to cure the adhesive.

16. The method according to claim 15, further comprising, after curing:
thermally curing the adhesive.

17. The method according to claim 14, further comprising, after rotating:
adjusting relative positions of the optical element and the image sensor.
